(19) United States
(12) Patent Application Publication
(10) Pub. No.: US 2014/0355503 A1
(43) Pub. Date: Dec. 4, 2014

(54) TRANSMITTING SERVICE ADVERTISEMENTS

(71) Applicants: Antti Kainulainen, Nummela (FI); Ville Ranki, Jorvas (FI); Fabio Belloni, Espoo (FI); Kimmo Kalliola, Espoo (FI)

(72) Inventors: Antti Kainulainen, Nummela (FI); Ville Ranki, Jorvas (FI); Fabio Belloni, Espoo (FI); Kimmo Kalliola, Espoo (FI)

(21) Appl. No.: 14/361,288

(22) PCT Filed: Dec. 2, 2011
(86) PCT No.: PCT/IB2011/055440

§ 371 Date: May 28, 2014

(51) Int. Cl. H04W 52/02; H04W 64/00

(52) U.S. Cl. CPC H04W 52/0229; H04W 52/0206; H04W 64/00; H04W 88/08
USPC 370/311

(57) ABSTRACT

Apparatus (30) comprises a battery power supply, a radio-frequency transceiver, a multi-element antenna, and processor and memory. Software causes the apparatus (30): when in an idle mode, to broadcast positioning service advertisements and to refrain from broadcasting positioning packets, when in a positioning mode to broadcast positioning packets from each of the elements of the antenna (32A-C) such as to allow a mobile device (10) to determine a bearing to the mobile device (10) from the apparatus (30), and to transition from the idle mode to the positioning mode in response to receiving either a) a wake-up command or b) a positioning packet, from another apparatus including a multi-element antenna. The apparatus (30) may comprise a Bluetooth Low Energy transceiver; and software that causes the apparatus (30): to transmit advertisements for positioning services on a first channel; and to broadcast positioning packets on a second channel such as to allow a mobile device (10) to determine a bearing to the mobile device (10) from the apparatus (30), wherein the first and second channel are on different frequencies.

### FIELD OF THE INVENTION

This relates to transmitting service advertisements.

### BACKGROUND TO THE INVENTION

There are a number of known techniques for determining the position of an apparatus using radio frequency signals. Some popular techniques relate to use of the Global Positioning System (GPS), in which multiple satellites orbiting Earth transmit radio frequency signals that enable a GPS receiver to determine its position. However, GPS is often not very effective in determining an accurate position indoors.

Some non-GPS positioning techniques enable an apparatus to determine its position indoors. An example technique is described by inventors of the present invention in WO 2011/107825.

### SUMMARY

A first aspect of the invention provides apparatus comprising:
a battery power supply,
a radio-frequency transceiver,
a multi-element antenna, and
processor and memory including software that when executed by the processor controls it to cause the apparatus:
when in an idle mode, to broadcast positioning service advertisements and to refrain from broadcasting positioning packets,
when in a positioning mode to broadcast positioning packets from each of the elements of the antenna such as to allow a mobile device to determine a bearing to the mobile device from the apparatus, and
to transition from the idle mode to the positioning mode in response to receiving either a) a wake-up command or b) a positioning packet, from another apparatus including a multi-element antenna.

The apparatus may be configured when in the positioning mode to respond to receiving an advertisement by transmitting a wake-up command.

The wake-up command includes a system identifier and wherein the apparatus may be configured when in the idle mode to be responsive to receiving a wake-up command including a system identifier to compare the system identifier to a system identifier stored in the apparatus and to transition from the idle mode to the positioning mode only if there is a match between the two system identifiers.

The apparatus may be configured when in the idle mode to activate a receiver of the transceiver for a relatively short proportion of the time between successive advertisement broadcasts and to deactivate the receiver for the remaining proportion of the time between the successive advertisement broadcasts.

The apparatus may be configured when in the positioning mode to broadcast advertisements. The apparatus may be configured when in the positioning mode to broadcast advertisements periodically.

The positioning mode may comprise a positioning activation mode and a regular positioning mode, and the apparatus may be configured to transition to the positioning activation mode from the idle mode and to transition to the regular positioning mode from the positioning activation mode.

The apparatus may be configured to transmit the advertisements on an advertising channel and to transmit the positioning packets on a different channel.

A second aspect of the invention provides a method of operating apparatus comprising:
a battery power supply,
a radio-frequency transceiver,
a multi-element antenna, and
processor and memory including software,
   the method comprising:
when in an idle mode, broadcasting positioning service advertisements and refraining from broadcasting positioning packets,
when in a positioning mode, broadcasting positioning packets from each of the elements of the antenna such as to allow a mobile device to determine a bearing to the mobile device from the apparatus, and
transitioning from the idle mode to the positioning mode in response to receiving either a) a wake-up command or b) a positioning packet, from another apparatus including a multi-element antenna.

The method may comprise, when the apparatus is in the positioning mode, responding to receiving an advertisement by transmitting a wake-up command.

The wake-up command may include a system identifier and when the apparatus is in the idle mode the method may comprise responding to receiving a wake-up command including a system identifier by comparing the system identifier to a system identifier stored in the apparatus and transitioning from the idle mode to the positioning mode only if there is a match between the two system identifiers.

The method may comprise when the apparatus in the idle mode activating a receiver of the transceiver for a relatively short proportion of the time between successive advertisement broadcasts and deactivating the receiver for the remaining proportion of the time between the successive advertisement broadcasts.

The method may comprise broadcasting advertisements when the apparatus is in the positioning mode. The method may comprise broadcasting advertisements periodically when the apparatus is in the positioning mode.

The positioning mode may comprise a positioning activation mode and a regular positioning mode, and the method may comprise the apparatus transitioning to the positioning activation mode from the idle mode and transitioning to the regular positioning mode from the positioning activation mode.

The method may comprise transmitting the advertisements on an advertising channel and transmitting the positioning packets on a different channel.

A third aspect of the invention provides a computer program comprising instructions that when executed by computer apparatus comprising a battery power supply, a radio-frequency transceiver, and a multi-element antenna control it to perform the method above.

A fourth aspect of the invention provides non-transitory computer-readable storage medium having stored thereon computer-readable code, which, when executed by computing apparatus comprising a battery power supply, a radio-frequency transceiver, and a multi-element antenna, causes it to perform a method comprising:
when in an idle mode, broadcasting positioning service advertisements and refraining from broadcasting positioning packets,
when in a positioning mode, broadcasting positioning packets from each of the elements of the antenna such as to allow a mobile device to determine a bearing to the mobile device from the apparatus, and
transitioning from the idle mode to the positioning mode in response to receiving either a) a wake-up command or b) a positioning packet, from another apparatus including a multi-element antenna.

A fifth aspect of the invention provides apparatus comprising:
a Bluetooth Low Energy transceiver; and
processor and memory including software that when executed by the processor controls it to cause the apparatus:
   to transmit advertisements for positioning services on a first channel; and
   to broadcast positioning packets on a second channel such as to allow a mobile device to determine a bearing to the mobile device from the apparatus,
      wherein the first and second channel are on different frequencies.

The apparatus may be configured to operate the receiver to listen for transmissions on the first channel for a period of time after the transmission of an advertisement on the first channel. Alternatively, the apparatus may be configured to operate the receiver to listen for transmissions on the second channel for a period of time after the transmission of an advertisement on the first channel.

The apparatus may be configured to respond to receiving a transmission comprising a) a request for positioning services, b) an advertisement for positioning services or c) a wake-up request on the first channel to transition from an idle mode in which positioning packets are not broadcast to a positioning mode in which positioning packets are broadcast.

The apparatus may be configured to respond to receiving a positioning packet on the second channel to transition from an idle mode in which positioning packets are not broadcast to a positioning mode in which positioning packets are broadcast.

A sixth aspect of the invention provides a method of operating apparatus comprising:
a Bluetooth Low Energy transceiver; and
processor and memory including software,
   the method comprising:
transmitting advertisements for positioning services on a first channel; and
broadcasting positioning packets on a second channel such as to allow a mobile device to determine a bearing to the mobile device from the apparatus,
   wherein the first and second channel are on different frequencies.

The method may comprise operating the receiver to listen for transmissions on the first channel for a period of time after the transmission of an advertisement on the first channel.

The method may comprise operating the receiver to listen for transmissions on the second channel for a period of time after the transmission of an advertisement on the first channel.

The method may comprise responding to receiving a transmission comprising a) a request for positioning services, b) an advertisement for positioning services or c) a wake-up request on the first channel by transitioning from an idle mode in which positioning packets are not broadcast to a positioning mode in which positioning packets are broadcast.

The method may comprise responding to receiving a positioning packet on the second channel by transitioning from an idle mode in which positioning packets are not broadcast to a positioning mode in which positioning packets are broadcast.

A seventh aspect of the invention provides a computer program comprising instructions that when executed by computer apparatus comprising a Bluetooth Low Energy transceiver control it to perform the method above.

An eighth aspect of the invention provides a non-transitory computer-readable storage medium having stored thereon computer-readable code, which, when executed by computing apparatus comprising a Bluetooth Low Energy transceiver causes it to perform a method comprising:
transmitting advertisements for positioning services on a first channel; and
broadcasting positioning packets on a second channel such as to allow a mobile device to determine a bearing to the mobile device from the apparatus,
   wherein the first and second channel are on different frequencies.

### BRIEF DESCRIPTION OF THE DRAWINGS

For a better understanding of various embodiments of the present invention reference will now be made by way of example only to the accompanying drawings in which:

FIG. 1 illustrates an apparatus receiving radio signals from a transmitter;

FIG. 2A is a schematic of a transmitter apparatus;

FIG. 2B is a schematic of a receiver apparatus;

FIG. 3 is a flow diagram of a method of estimating a position of the apparatus;

FIG. 4 illustrates a schematic for estimating the position of the apparatus using a displacement or range as a constraint;

FIG. 5 illustrates a schematic for estimating the position of the apparatus using an additional bearing from another location as a constraint;

FIG. 6 is a schematic of the receiver apparatus of FIG. 2A with additional features;

FIG. 7 schematically illustrates an example of a method of operating the apparatus of FIGS. 2A and 6; and

FIGS. 8 to 11 show operation of the apparatus of FIG. 2A in different scenarios.

### DETAILED DESCRIPTION OF VARIOUS EMBODIMENTS OF THE INVENTION

The Figures illustrate detecting, at an apparatus 10, radio signals 50 from a first location 80; using the one or more detected radio signals to estimate a bearing 82 from the first location 80; and positioning of the apparatus 10 using the bearing.

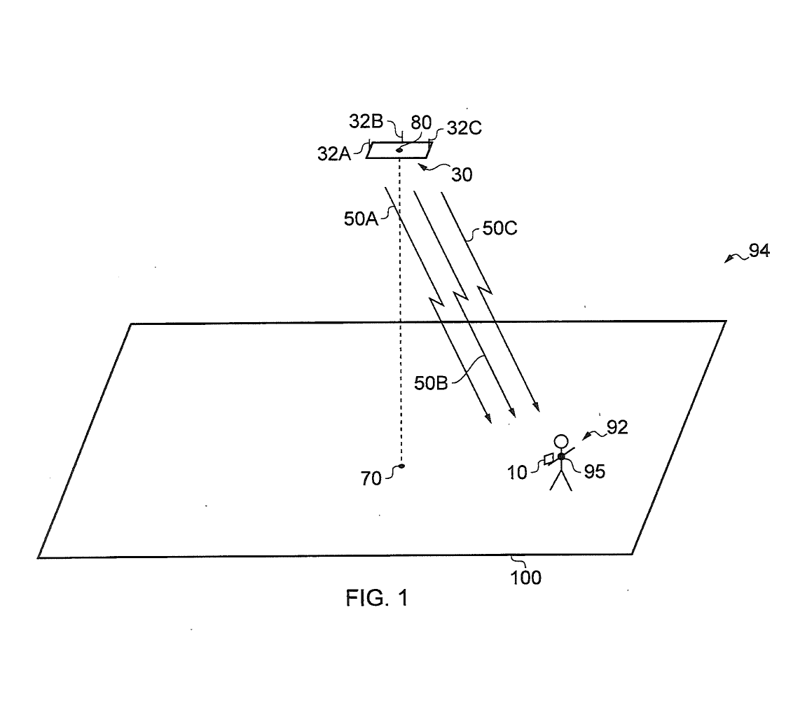

FIG. 1 illustrates a person 92 (carrying a receiver apparatus 10) at a position 95 on a floor 100 of a building 94. The building 94 could be, for example, a shopping centre or a conference centre.

A base station transmitter 30 is positioned at a location 80 of the building 94. In the illustrated example, the location 80 is on the ceiling of the building 94 (i.e. the overhead interior surface) but in other implementations the transmitter may be placed elsewhere such as on a wall. The base station transmitter 30 may be termed a directional transceiver (DT).

The location 80 is directly above the point denoted with the reference numeral 70 on the floor 100 of the building. The transmitter 30 is for enabling a user of an apparatus 10, such as the person 92, to determine his position 95, although that is not necessarily the only function provided by the transmitter 30. For example, the transmitter 30 may be part of a transceiver for providing wireless internet access to users of apparatuses 10, for example, via wireless local area network (WLAN) radio signals.

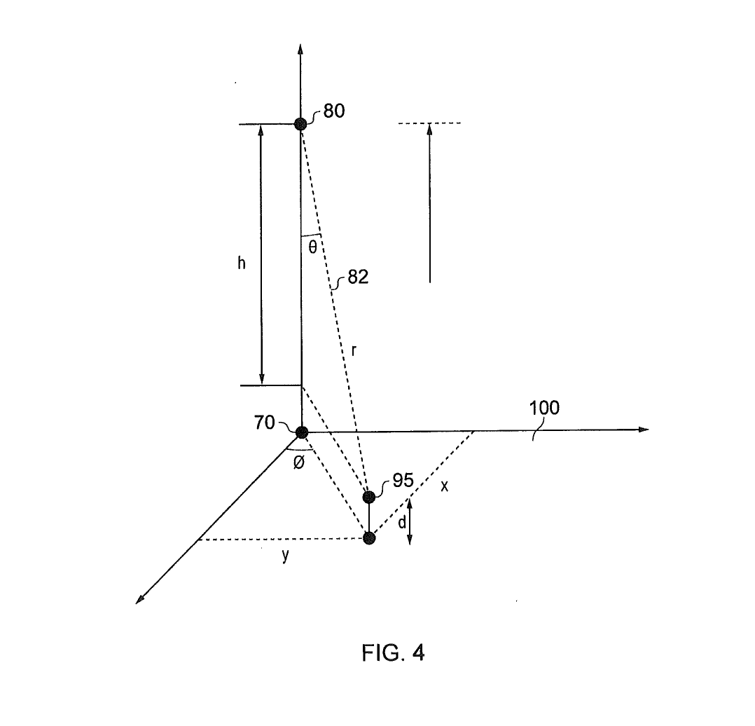

The position 95 of the person 92 is defined by specifying a position along a bearing 82 (illustrated in FIG. 4) which runs from the location 80 of the transmitter 30 through the location 95 of the apparatus 10. The bearing 82 is defined by an elevation angle θ and an azimuth angle Φ.

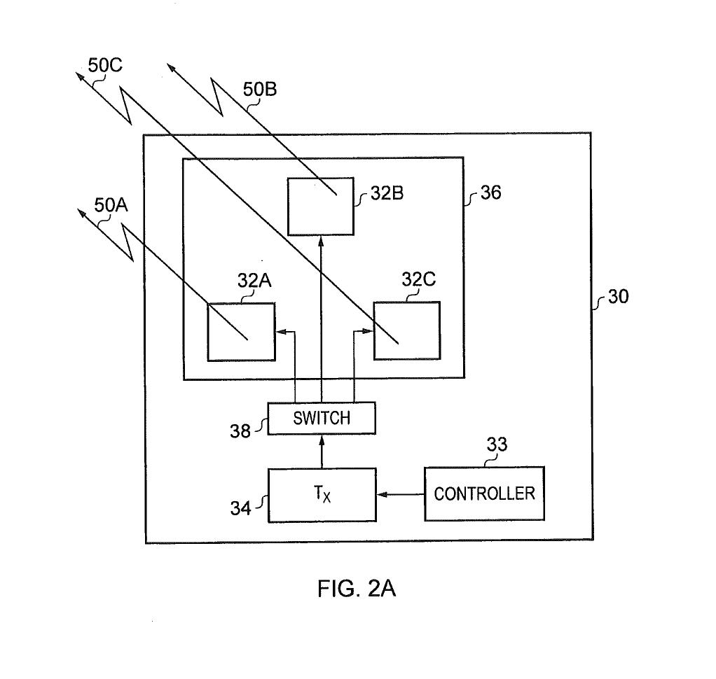

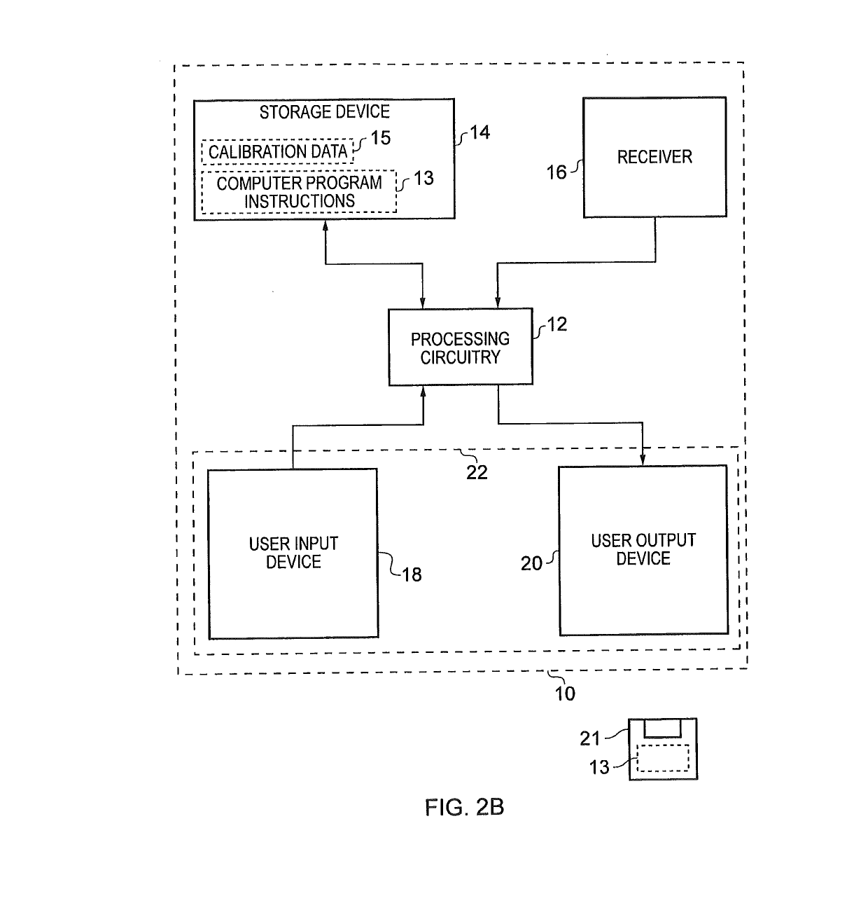

FIG. 2A schematically illustrates one example of the base station transmitter 30. The transmitter 30 comprises a controller 33, transmitter circuitry 34 and an antenna array 36 comprising a plurality of antenna elements 32A, 32B, 32C which transmit respective radio signals 50A, 50B, 50C.

The one-way radio signals 50 may be transmitted as beacons by the transmitter 30. The beacons are broadcast to multiple mobile apparatus simultaneously. The beacons may be termed positioning packets.

In the illustrated example, separate signals 50 are transmitted via the array 36 of antenna elements 32 in a time division multiplexed fashion. A switch 38 is used to connect each one of the antenna elements 32 to the transmitter circuitry 34 one at a time, in a predefined order. The radio signals 50A, 50B, 50C from the different antenna elements 32A, 32B, 32C are therefore transmitted sequentially in different slots of a frame. In the Figure only three different displaced antenna elements 32 are illustrated, although in actual implementations more antenna elements 32 may be used. For example 16 patch antenna elements could be distributed over the surface of a hemisphere. Three is the minimum number of radio signals required at the receiver apparatus 10 to be able to determine a bearing 82.

In other embodiments, there may be a separate transmitter circuit 34 associated with each antenna element 32. In these embodiments, it may be possible to transmit one or more of the signals 50 in parallel.

Each signal 50 has a characteristic that enables it to be discriminated by the receiver apparatus 10. The characteristic may be a feature of the signal itself such as a code sequence that has been modulated onto a carrier wave or it may be a feature of the signal's position relative to the other signals such as its ‘slot’ number within a frame. In the latter case, all of the signals in the slots of a frame may have the same or different code sequences.

The receiver apparatus 10 needs to obtain ‘displacement information’ from the received signals 50A, 50B, 50C that is dependent upon inter alia the relative displacements of the respective antenna elements 32A, 32B, 32C. In the example described in detail below, the displacement information includes phase information.

In some embodiments, a carrier wave is modulated using convolution codes, as in code division multiple access. Explicit displacement information may then be determined at a receiver apparatus 10 by correlating the expected code against the received signal 50. One advantage of this approach is that knowledge of how the array 36 of antenna elements 32 transmits is not required at the receiver as the displacement information is determined from data encoded onto the carrier rather than from a property of the carrier itself.

In other embodiments, the carrier wave is modulated using 1-Q modulation, also known as quadrature phase shift modulation. In this modulation technique, two orthogonal carrier waves (sine and cosine) are independently amplitude modulated to define a symbol. At the receiver apparatus 10, the amplitude of the two orthogonal carrier waves is detected as a complex sample and the closest matching symbol determined. It will be appreciated that an identical signal transmitted from different antenna elements is received with different phases because of the inherent phase characteristics of the antenna elements 32 when transmitting in different directions and also because of the additional time of flight for a signal 50 from one antenna element to reach the receiver apparatus 10 compared to another signal 50. The inherent presence of this ‘time of flight’ information within the phases of the received signals 50 enables the received signals 50 to be processed, as described in more detail below, to determine the bearing 82 of the receiver apparatus 10 from the transmitter 30.

One advantage of this approach is that the resolution required for the displacement information to be able to resolve relative spatial separation between the antenna elements 32 of a few centimetres would require a carrier frequency of the order 10 GHz but a much lower modulation rate may be used and therefore correspondingly small bandwidth and slower clock can be used.

One disadvantage of this approach is that knowledge of how an antenna array 36 transmits is required at the receiver apparatus 10 as the inherent displacement information is determined from a property (phase) of the carrier itself and antenna elements 32 typically transmit with different phase offsets at different angles. This knowledge may take the form of an array transfer function.

FIG. 2B illustrates a schematic of a receiver apparatus 10. The apparatus 10 may, for example, be a mobile phone. The apparatus 10 comprises processing circuitry 12, a storage device 14, a receiver 16, a user input device 18 and a user output device 20.

The processing circuitry 12 uses one or more detected radio signals 50 to estimate a bearing 82 from the first location 80; and uses the bearing estimate 82 to determine whether further detection of one or more radio signals is required before positioning the apparatus 10; and positioning of the apparatus 10 using a bearing and constraint information. The portable apparatus itself does not need to transmit to determine its position. Furthermore it alone may perform the processing necessary to determine a bearing 82 and to estimate, using the bearing and constraint information, the position of the apparatus 10 along the bearing 82. The processing circuitry 12 may be any type of processing circuitry. For example, the processing circuitry 12 may be a programmable processor that interprets computer program instructions 13 and processes data. Alternatively, the processing circuitry 12 may be, for example, programmable hardware with embedded firmware. The processing circuitry 12 may be a single integrated circuit or a set of integrated circuits (i.e. a chipset). The processing circuitry 12 may be a hardwire, application-specific integrated circuit (ASIC).

It will be appreciated by those skilled in the art that, for clarity, the processing circuitry is described as being a separate entity to the receiver. However, it will be understood that the term processing circuitry may relate not only to a main processor of an apparatus, but also processing circuitry included in a dedicated receiver chip set, and even to a combination of processing circuitry included in a main processor and a dedicated receiver chipset.

A chip set for performing embodiments of the invention may be incorporated within a module. Such a module may be integrated within the apparatus 10, and/or may be separable from the apparatus 10. The processing circuitry 12 is connected to receive an input from the receiver 16. The receiver 16 is configured to receive radio frequency signals. The radio signals may, for instance, have a transmission range of 100 meters or less. For example, the radio frequency signals may be 802.11 wireless local area network (WLAN) signals, Bluetooth signals, Ultra wideband (UWB) signals or Zigbee signals. The processing circuitry 12 is connected to write to and read from the storage device 14. The storage device 14 may be a single memory unit or a plurality of memory units.

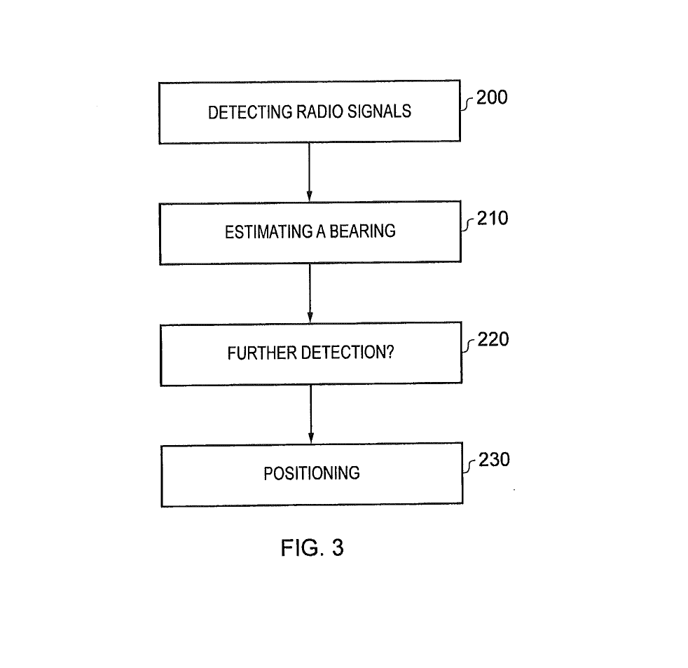

The storage device 14 may store computer program instructions 13 that control the operation of the apparatus 10 when loaded into processing circuitry 12. The computer program instructions 13 may provide the logic and routines that enables the apparatus to perform the method illustrated in FIG. 3.

The computer program instructions 13 may arrive at the apparatus 10 via an electromagnetic carrier signal or be copied from a physical entity 21 such as a computer program product, a memory device or a record medium such as a CD-ROM or DVD.

The computer program instructions 13 provide: instructions for discriminating 210 between radio signals 50 received from a first location 80 by the receiver 16, in order to estimate 220 a bearing 82 from the first location 80; and instructions for estimating 230, using the bearing 82 and constraint information that is independent of the radio signals 50, a position of the receiver 16.

The processing circuitry 12 is connected to receive an input from the user input device 18. The processing circuitry 12 is also connected to provide an output to the user output device 20. The user output device 20 is for conveying information to a user and may be, for example, a display device. The user input device 18 and the user output device 20 together form a user interface 22. The user interface 22 may be provided as a single unit, such as a touch screen display device. FIG. 3 illustrates a method for estimating the position of the apparatus 10.

Various embodiments of the method of FIG. 3 will be described hereinafter. Although the method will be described in the context of diversity transmission, it should be appreciated that it is also applicable to diversity reception. In diversity transmission, multiple radio signals are sent from spatially diverse antennas as illustrated in FIG. 1. In diversity reception, a radio signal is received at spatially diverse antennas. In the following it will be assumed that the respective spatially diverse transmitted radio signals 50A, 50B, 50C illustrated in FIGS. 1 and 2 are sent in different slots of a TDMA frame and that the same code is modulated onto the signals using IQ modulation, in this case Binary Phase Shift Key (BPSK) modulation as it is the most robust. It will be appreciated that in other embodiments different types of signals may be used and different methods of discriminating the signals will be required.

At block 200 of the method of FIG. 3, the receiver 16 of the apparatus 10 detects radio signals 50 including first, second and third radio signals 50A, 50B, 50C.

At block 210, the processing circuitry 12 of the apparatus 10 uses the detected radio signals 50 to estimate a bearing 82 of the apparatus 10 from the first location 80.

The processing circuitry 12 may discriminate between the respective radio signals 50. In this example, this may be achieved by identifying in which slot in the TDMA frame the signal was received. At least three respective radio signals 50A, 50B and 50C are discriminated. The processing circuitry 12 obtains comparable complex samples (i.e. samples that represent same time instant) for the three respective radio signals 50A, 50B, 50C. In some embodiments, the transmitter 30 may transmit calibration data 15 in a radio signal to the apparatus 10 for storage in memory 14, before the transmission of the radio signals 50, to enable the processing circuitry 12 of the apparatus 10 to discriminate between the radio signals 50. The calibration data 15 may, for example, be transmitted periodically as a beacon signal by the transmitter 30. In the described example, the calibration data 15 may include discrimination data that identifies the code used to modulate the signals, information about the TDMA frame, and possible information identifying the IQ modulation used and antenna array calibration data that includes information that defines the transfer function of the antenna array 36.

The calibration data 15 may be encrypted. A key to decrypt the calibration data 15 may be available from a remote server. For example, if the transmitter 30 is part of a transceiver for providing internet access, the decryption key may be obtainable from a remote server that is accessible via the transceiver. In an embodiment where the apparatus 10 also functions as a mobile telephone, the decryption key may be obtainable from a remote server connected to a mobile telephone network.

Alternatively, the calibration data 15 itself may be available from a remote server via a mobile telephone network, rather than from the transmitter 30.

The processing circuitry 12 then estimates a bearing 82. One method of determining the bearing 82 is now described, but other methods are possible.

Once comparable complex samples (i.e. samples that represent same time instant) from each antenna element 32 are obtained the array output vector y(n) (also called as snapshot) can be formed at by the processing circuitry 12.

y(n)=[x₁, x₂, . . . , x_{M}]^{T}, (1)

where x, is the complex signal received from the ith TX antenna element 32, n is the index of the measurement and M is the number of TX elements 32 in the array 36.

A Direction of Departure (DoD) can be estimated from the measured snapshots if the complex array transfer function a(φ,θ) of the TX array 36 is known, which it is from calibration data 15.

The simplest way to estimate putative DoDs is to use beamforming, i.e. calculate received power related to all possible DoDs. The well known formula for the conventional beamformer is

P_{BF}(φ,θ)=a*(φ,θ)\hat{R}a(φ,θ), (2)

### Where,

$$\hat{R} = \frac{1}{N} {\sum }_{n = 1}^{N} y ( n ) {y}^{*} ( n )$$

is the sample estimate of the covariance matrix of the received signals, a(φ,θ) is the array transfer function related to the DoD (φ,θ), φ is the azimuth angle and θ is the elevation angle.

Once the output power of the beamformer P_{BF}(φ,θ) is calculated in all possible DoDs the combination of azimuth and elevation angles with the highest output power is selected to be the bearing 82.

The performance of the system depends on the properties of the TX array 36. For example the array transfer functions a(φ,θ) related to different DoDs should have as low correlation as possible for obtaining unambiguous results. Correlation depends on the individual radiation patterns of the antenna elements 32, inter element distances and array geometry. Also the number of array elements 32 has an effect on performance. The more elements 32 the array 36 has the more accurate the bearing estimation becomes. In minimum there should be at least three antenna elements 32 in planar array configurations but in practice 10 or more elements should provide good performance.

Next, at block 220 the processing circuitry 12 uses the determined bearing estimate 82 to determine whether further detection of one or more radio signals is required before positioning the apparatus.

Next, at block 230 the processing circuitry 12 estimates a position of the apparatus 10 using a bearing and constraint information. In some embodiments of the invention, the use of constraint information enables the processing circuitry 12 to determine the location of the apparatus 10 along the estimated bearing 82.

FIG. 4 also illustrates the bearing 82 from the location 80 of the transmitter 30 to the location 95 of the apparatus 10, which has been estimated by the processing circuitry 12 following reception of the radio signals 50. The bearing 82 is defined by an elevation angle θ and an azimuth angle Φ.

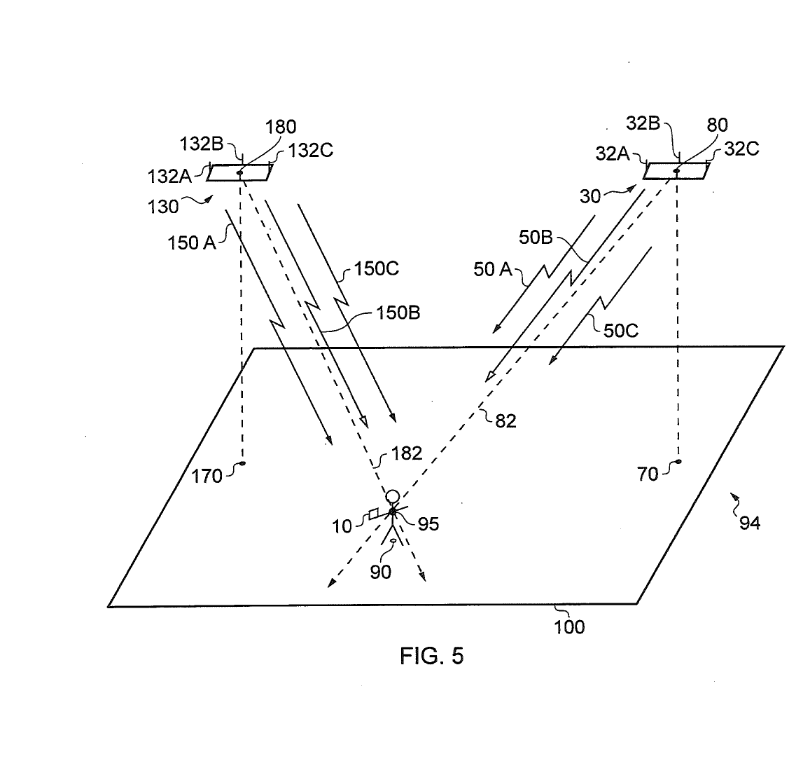

The processing circuitry 12 may estimate the position of the apparatus 10 relative to the location 80 of the transmitter 30 in coordinates using the bearing (elevation angle θ, azimuth angle Φ) and constraint information e.g. vertical displacement h (FIG. 4) or an additional bearing (FIG. 5). The processing circuitry 12 may estimate the position of the apparatus 10 in Cartesian coordinates by converting the coordinates using trigonometric functions.

FIG. 5 illustrates a building 94 having two transmitters 30, 130 located on the ceiling of the building 94 in this example. The two transmitters 30, 130 are of the same form as that of the transmitter 30 described in relation to in FIG. 1. The first transmitter 30 is positioned at a location 80 on the ceiling, directly above the point denoted with the reference numeral 70 on a floor 100 of the building 94. The second transmitter 130 is positioned at a location 180 on the ceiling, directly above the point denoted with the reference numeral 170 on the floor 100. The separation of the transmitters 30, 130 is large in comparison with the separation of the antenna elements 32 or 132 with their respective arrays.

The apparatus 10 receives radio signals 50 from the first transmitter 30 and determines a bearing 82 of the apparatus 10 as described in relation to FIG. 3.

The apparatus 10 also receives radio signals 150 from the second transmitter 130 and determines, as constraint information, a bearing 182 of the apparatus 10 from the first transmitter 30 using the method as described in relation to FIG. 3. The discrimination of the radio signals 150A, 150B, 150C at block 210 and the estimation of the bearing 182 utilises second calibration data including, for example, the transfer function of the antenna array used by the second transmitter 130.

The apparatus 10 receives second calibration data from the second transmitter 130. Once the bearings 82 and 182 have been estimated, the processing circuitry 12 may estimates that the apparatus 10 is situated at a position along bearing 82 as defined by the constraining bearing 182. It may be that processing circuitry 12 estimates an area that the apparatus 10 is likely to be positioned in if the accuracy of the bearings 82, 182 is such that the processing circuitry 12 is not able to pinpoint the position of the apparatus 10 with a high degree of precision.

Once the position of the apparatus 10 has been estimated, the processing circuitry 12 may control the user output device 20 to convey the estimated position to the user.

The arrangement thusfar described is as illustrated and described in WO 2011/107825. Manners in which the embodiments of the present invention are distinguished from this earlier patent publication will now be described.

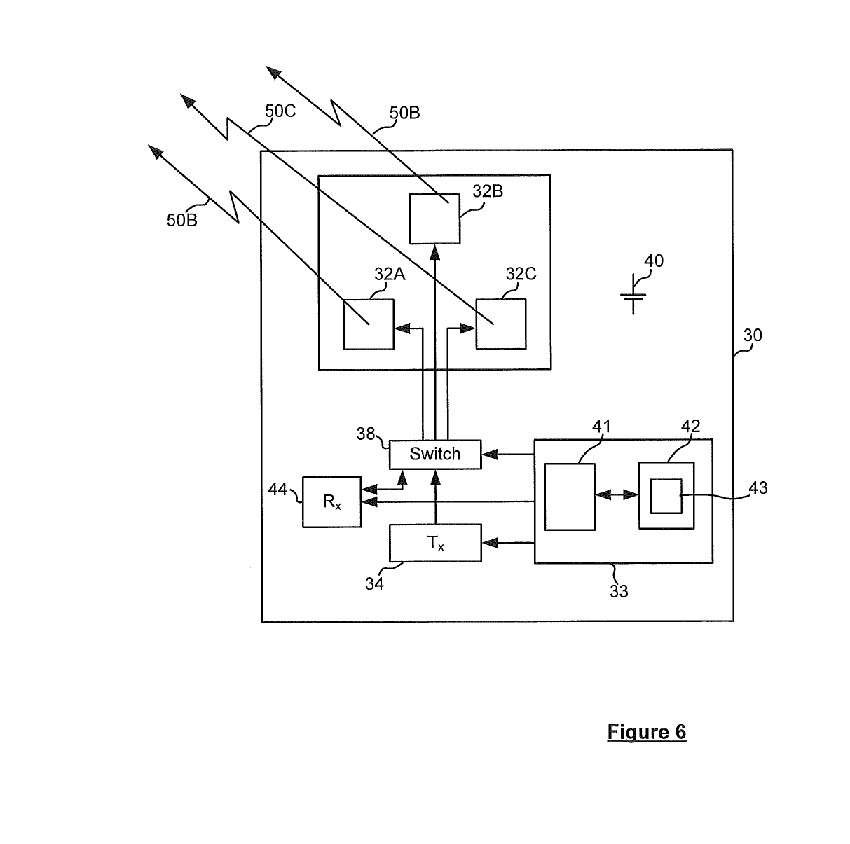

Firstly, the directional transceiver 30 is powered by a battery. The DT 30 does not have a connection to a mains electricity supply. The battery is shown at 40 in FIG. 6. The battery 40 powers all of the other components of the DT 30, including the controller 33, the transmitter 34 and the switch 38. Also shown in FIG. 6 is a modified form of controller 33. The controller 33 includes a processor 41 and a memory 42. The processor 41 and the memory 42 are in communication with one another. The memory 42 contains within one or more computer programs 43. The computer programs include software computer instructions that, when executed by the processor 41, cause the controller 33 to execute appropriate control of the other components of the DT 30.

The memory 42 may be a non-volatile memory such as read only memory (ROM) a hard disk drive (HDD) or a solid state drive (SSD). The memory 42 is used for the temporary storage of data, for the execution of software, as well as for permanent storage. Alternatively, there may be separate memories 42 for temporary and non-temporary storage, such as RAM and ROM.

The processor 41 may take any suitable form, and may for instance be a single processor, multiple processors, a multi-core processor or plural multi-core processors.

The DT 30 also includes a receiver 44. The receiver is configured to be controlled by the controller 33. The controller 33 also controls the switch 38. The receiver is connected to the antenna 36 by the switch 38. Using the receiver 44, the controller 33 can receive signals transmitted by mobile devices 10 and/or other DTs 130.

The use of the battery 40 to power the DT 30 provides challenges. There is an inherent conflict between the requirement to provide positioning packets at suitable times so as to allow mobile devices to be able to determine their location with maximising intervals between successive replacement of the battery 40 and/or charging of the DT 30. It is considered to be advantageous to reduce the power consumption of the DT 30, thereby prolonging the life of the battery 40, whilst providing a satisfactory level of positioning service to mobile devices 10. In some embodiments, the DT is connected to a source of mains electricity that is available only periodically, for instance a power supply of a lighting circuit. In these embodiments, it is desirable for the DT 30 to be able to achieve its functions on power stored in its internal battery in the time between the power supply switching off (e.g. in the morning) and being switched on again (e.g. in the evening).

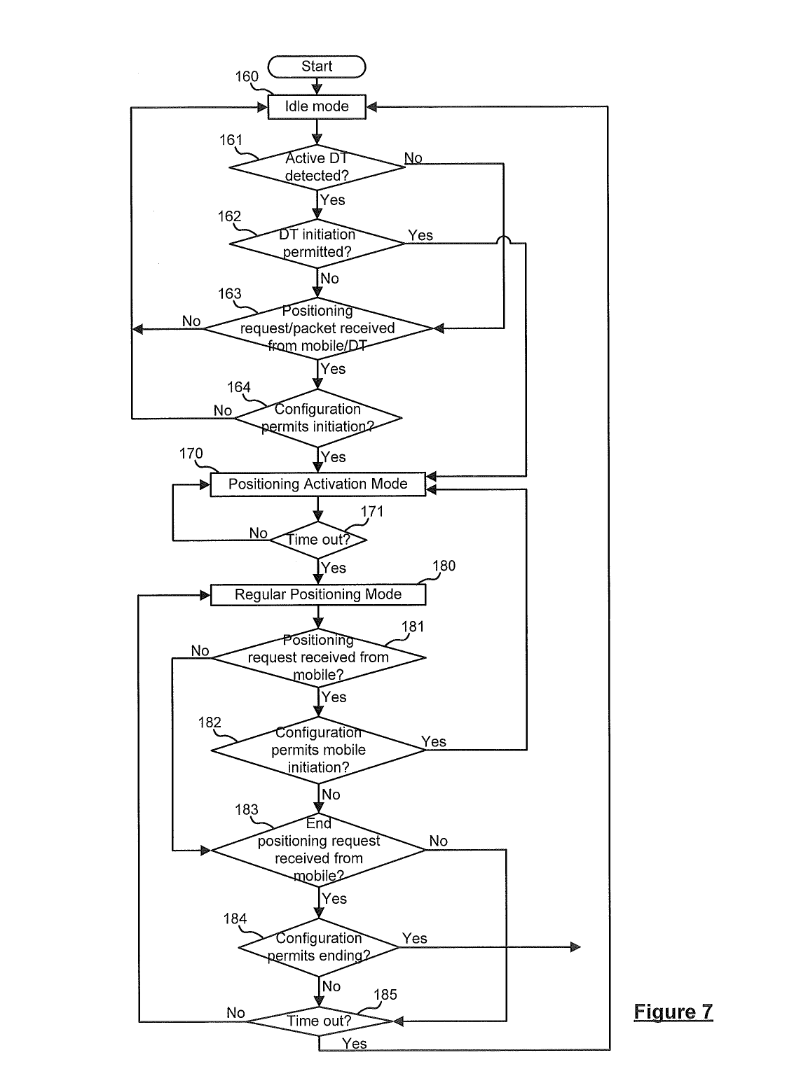

Operation of the DT 30 will now be described with reference to FIG. 7, which is a flow chart illustrating modes in which the DT 30 can be present and steps taken by the DT.

When in an idle mode 160, the DT 30 is operational as follows. In the idle mode 160, the DT 30 transmits an advertisement for positioning services periodically. The advertisement may be a Bluetooth low energy (BLE) advertisement. The advertisement has contents that are such as to invite devices that receive the advertisement to request positioning services from the DT 30, and may take any suitable form.

Intervals between successive advertisements are relatively high, for instance of the order of one second. Intervals between successive advertisements may take any suitable value, for instance they may take a value between 100 milliseconds and 5 seconds. BLE advertisements are transmitted on an advertisement channel.

Immediately following the transmission of an advertisement, the DT 30 activates the receiver 44 in order to detect any signals that have been transmitted by mobile devices 10 or by other DTs 130. The time for which the receiver 44 is switched on immediately following the transmission of an advertisement can be termed the scanning time. The scanning time is relatively short. For instance, the scanning time can be 10 milliseconds. The scanning time may take any value between one millisecond and 50 milliseconds, for instance. In the scanning time, the DT 30 may listen for signals that are transmitted on the advertisement channel, on which the advertisement was transmitted.

The DT 30 may also listen for transmissions on a positioning channel. The positioning channel may have a different channel parameter, e.g. frequency, to the advertisement channel. In listening for signals transmitted by mobile devices 10 or other DTs 130, the controller 33 controls the receiver 44 to demodulate signals received by the antenna elements 36. The DT 30 may listen or transmissions on the positioning channel after, for instance immediately after, listening for transmissions on the advertisement channel.

In the idle mode, positioning packets are not transmitted by the DT 30.

In a positioning activation mode 170, operation of the DT 30 is as follows. In the positioning activation mode, the DT 30 transmits positioning packets. The positioning packets, as described above, can be used by mobile devices 10 for calculating their position. Their positioning packets are broadcast on the positioning channel, if one is provided. The positioning packets may include a positioning system identifier, which is an identifier stored in the memory 42.

The rate of transmission of positioning packets in the positioning activation mode 170 is relatively high. For instance, packets may be transmitted at a rate of 100 per second. The rate of transmission of positioning packets may instead take another value, for instance between 10 packets per second and 500 packets per second. The high rate of transmission of positioning packets provides a relatively high probability that mobile devices 10 and other DTs 130 will detect the transmitted positioning packets.

When in the position activation mode 170, the receiver 44 of the DT 30 may not be activated. Alternatively, the receiver 44 may be activated for some or all of each interval between successive positioning packet transmissions.

Positioning activation mode 170 is typically enforced for a relatively short period of time. For instance, positioning activation mode may be enforced for a period of two seconds. Alternatively, positioning activation mode may be maintained for some other period, for instance between 0.2 seconds and 10 seconds.

For reasons that will become apparent, it is advantageous that the period of time in which the DT 30 remains in the positioning activation mode 170 is greater than the interval between successive transmissions of advertisements when in the idle positioning mode.

In a regular positioning mode 180, operation of the DT is as follows.

In the regular positioning mode, advertisements are transmitted on the advertising channel in the same way as described above in relation to the idle mode 160. Additionally, the DT 30 in the regular positioning mode 180 broadcasts positioning packets. The rate of broadcasting positioning packets in the regular positioning mode is lower than the rate of broadcasting positioning packets in the positioning activation mode 170. For instance, in the regular positioning mode the DT 30 may transmit positioning packets at a rate of 10 packets per second. The rate may take some other value, for instance between one packet per second and 50 packets per second. If a separate positioning channel is provided, the positioning packets are transmitted on the positioning channel and the advertisements are transmitted on the advertising channel.

In the positioning mode 180, the DT 30 listens for signals transmitted by other DTs on the advertising channel. This involves the controller 33 controlling the receiver 44 to demodulate signals received at the antennas 36. In response to receiving an advertisement packet from another DT 130, the DT 30 sends a positioning wake-up command to that other DT. In some embodiments, the positioning wake-up command is the same as a request for positioning services that may be transmitted by a mobile terminal 10. In other embodiments, the positioning wake-up command takes a different form, and in these embodiments a DT 30 can determine from the received signal whether the signal was transmitted by a DT 30 or by a mobile terminal 10. The positioning wake-up command may or may not include the system identifier that is stored in the memory 42. The positioning wake-up command is transmitted on the positioning channel if there are separate positioning and advertising channels.

In some embodiments, an advertisement transmitted by a DT indicates whether the DT is in the idle mode 160 or in the regular positioning mode 180. In these embodiments, the DT 30 responds to advertisements only if the advertisement indicates that the other DT is in the idle mode 160. In other embodiments, the advertisements do not indicate the mode in which the DT 30 is present.

The DTs 30 may be configured to remain in the regular positioning mode 180 for a certain time period before transitioning to the idle mode 160. The time in which the DTs 30 are configured to remain in their regular positioning mode may take any suitable value, for instance 10 seconds. It may alternatively be in the range of one second to 50 seconds. The time in which the DTs 30 are configured to remain in the regular positioning mode 180 advantageously is longer than the time for which the DTs are configured to remain in the positioning activation mode 170. A DT 30 transitions from the regular positioning mode 180 to the idle mode 160 after the time out period. The transition may occur alternatively if the DT 30 receives an end positioning service request from a trusted mobile device. The DT 30 may be configured to make this transition in response to receiving such a request only if this is permitted by its configuration.

The DT 30 is configured to transition from the idle mode 160 to the positioning activation mode 170 in response to one of three possible triggers. The first trigger is the detection of a positioning wake-up command from another DT 130. The transition from the idle mode 160 to the positioning activation mode 170 in such circumstance may be dependent on a configuration setting of the DT 30. A second possible trigger is the receipt of a positioning request from a mobile device 10. A third trigger by which the DT 30 can transition from the idle mode 160 to the positioning activation mode 170 is the receipt of a positioning packet from a DT 30. If there are different advertising and positioning channels, positioning service requests are received from mobile terminals 10 and positioning packets are received from other DTs 130 on different channels. Positioning wake-up commands may be received from DTs 130 on the advertising channel or the positioning channel, depending on the configuration of the other DTs 130.

Referring now to FIG. 7, after starting the operation, the DT 30 begins in idle mode 160. As discussed above, in the idle mode the DT 30 transmits an advertisement on the advertisement channel and then listens or scans for a short period of time immediately following the transmission of the advertisement for signals transmitted by mobile devices 10 and/or other DTs 130. Listening/scanning may be on the advertisement channel only, or may be on the positioning channel only. Listening/scanning may alternatively be on both the advertisement and positioning channels.

At step 161, it is determined whether an active DT 130 has been detected. This step involves determining whether a positioning wake-up command has been received from another DT. If there are separate positioning and advertising channels, this involves detecting a positioning wake-up command transmitted on the positioning channel. The receipt of a positioning wake-up command from another DT 130 indicates that the DT 30 expressly responded to the advertisement such as to cause the DT 30 to enter the positioning activation mode. In the event of a positive determination, it is determined at step 162 whether initiation of the positioning service by another DT 130 is permitted by the configuration of the DT 30. In the event of a positive determination, the DT 30 transitions to the positioning activation mode 170. In the event of a positive determination from step 161 or a negative determination from step 162, the operation proceeds to step 163.

Here, it is determined by the DT 30 whether a positioning service request has been received from a mobile terminal 10 or a positioning packet has been received from a DT 30. Such a positioning service request is one that is transmitted by the mobile terminal 10 in response to receiving the advertisement from the DT 30 when the mobile device 10 requires positioning packets to be transmitted.

On a negative determination from step 163, the operation proceeds again to cause the DT 30 to remain in the idle mode 160. On a positive determination, it is determined at step 164 whether the configuration of the DT 30 permits initiation of the positioning activation mode 170 based on the positioning request received from the mobile terminal 10 or a positioning packet received from the other DT 130. The configuration is stored in the memory 42. The configuration may indicate that entering the positioning activation mode is permitted by positioning requests received from mobile terminals 10 and not from positioning packets received from other DTs 130, or that the transition is permitted by positioning request received by DTs 30 and not from mobile devices, or that the transition is permitted by positioning requests received from mobile devices 10 or by positioning packet received from the other DTs 130.

When in the positioning activation mode 170, the DT 30 acts as described above. At step 171, the DT 30 determines whether the positioning mode time out has occurred. If it has not, the DT remains in the positioning activation mode 170. Once the time out has occurred, step 171 causes progression of the DT such that it transitions into the regular positioning mode 180.

In the regular positioning mode 180, the DT at step 181 determines whether a positioning service request has been received from a mobile device 10. Such a positioning service request is of the type transmitted by mobile devices 10 in response to advertisements when the mobile device requires positioning packets in order to determine its location. If the DT 30 determines that a positioning request has been received from a mobile device 10, at step 182 the DT 30 determines whether its configuration, stored in the memory 42, permits initiation by mobile devices of the positioning service. In the event of a positive determination, the DT 30 transitions to the positioning activation mode 170. In the event of a negative determination from either of steps 181 and 182, the operation proceeds to step 183. Here, it is determined whether an end positioning request has been received from a mobile device 10. In the event of a positive determination, it is determined at step 184 whether the configuration stored in the memory 42 permits ending of the provision of the positioning service by the receipt of end positioning requests from mobile devices 10. Step 184 may involve determination whether the mobile device from which the end positioning request was received at step 183 is a trusted mobile device. This can be achieved in any suitable way.

In the event of a positive determination from step 184, the DT 30 transitions to the idle mode 160. In the event of a negative determination at step 184 or a negative determination from step 183, at step 185 the DT 30 determines whether a time out has expired. This is the time out that determines the length of time in which the DT 30 stays in the regular positioning mode 180. If the time out is determined to have expired at step 185, the DT 30 transitions to the idle mode 160. If the time out has not expired, the DT 30 remains in the regular positioning mode 180.

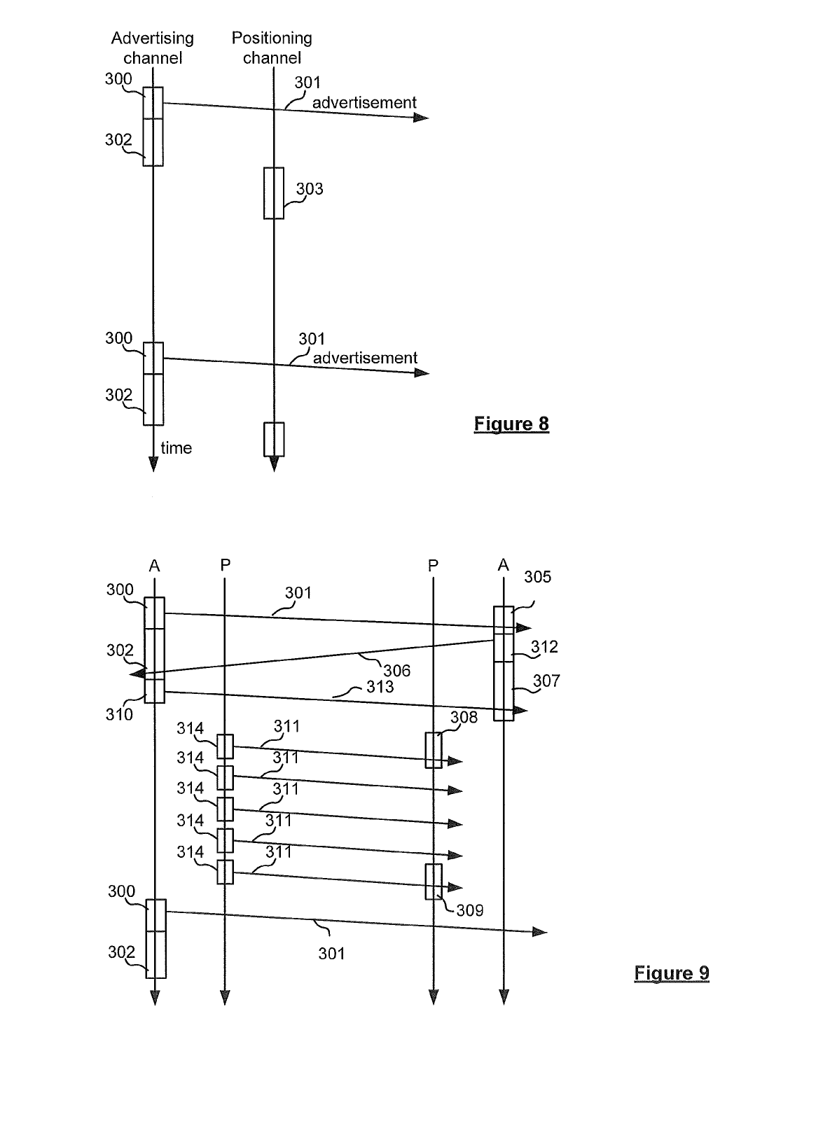

One particular embodiment, which is a specific one of the alternarives of the embodiment(s) described above in relation to FIGS. 6 and 7, will now be described with reference to FIGS. 8 to 11. In this embodiment, the DTs 30, 130 and the mobile devices 10 are configured to operate according to the Bluetooth Low Energy standard, and all transmission and reception/listening is according to the BLE protocols. In this embodiment, many of the features described above with relation to FIGS. 6 and 7 are implemented. Other features described with relation to FIGS. 6 and 7 that are not inconsistent with the specific features described with reference to FIGS. 8 to 11 are present in this embodiment.

In the following, ‘listen’ is used to refer to operating a receiver of the DT 30, 130 or the mobile device 10, as the case may be, to detect transmissions.

Operation of the DT 30 in the idle mode 160 is illustrated with reference to FIG. 8.

In FIG. 8 it is shown that the DT 30 transmits 300 an advertisement 301 on the advertisement channel. The transmission 300 has a first duration. The DT 30 then listens 302 on the advertising channel. Listening 302 immediately follows the transmission 300, or they may be a short interval therebetween. Listening 302 on the advertising channel occurs for a second duration (the scanning time), which in this example is longer than the duration of the advertisement transmission 300. After listening 302 on the advertising channel, the DT listens 303 on the positioning channel. Listening 303 on the positioning channel immediately follows the listening 302 on the advertising channel, or they may be a short interval therebetween. Listening 303 on the positioning channel is for a third duration, which may take any suitable value. It may for instance be about the same as the listening 302 on the advertising channel. The DT 30 transmits another advertisement 301 after the interval between successive advertisements.

Operation in arriving at and operation in the positioning activation mode 170 is illustrated with reference to FIG. 9. Here, it is shown that the DT 30 transmits 300 an advertisement 301 on the advertisement channel. The transmission 300 has a first duration. The DT 30 then listens 302 on the advertising channel. Listening 302 immediately follows the transmission 300, or they may be a short interval therebetween. Listening 302 on the advertising channel occurs for a second duration (the scanning time), which in this example is longer than the duration of the advertisement 301 transmission 300.

In parallel, a mobile device 10 has identified a need to receive positioning packets. In response, the mobile device 10 begins to listen 305 on the advertising channel. Whilst listening 305, the mobile device 10 receives the advertisement 301 from the DT 30. In response, the mobile device 10 immediately sends 312 a request 306 for positioning services. This is sent on the advertising channel. Immediately following transmission 312 of the request 306 for positioning services, the mobile device 10 listens 307 on the advertising channel for a response from the DT 30. The duration of the listening 307 on the advertisement channel is relatively short.

If the mobile device 10 does not receive an acknowledgement during the listening 307 on the advertisement channel, it listens 305 again for advertisements from DTs 30, 130.

If during the listening 307 on the advertisement channel the mobile device 10 receives an acknowledgement 313 from the DT 30, the mobile device 10 tunes to the positioning channel. An interval after receiving the acknowledgment 313, the mobile device 10 listens 308 on the positioning channel. The mobile device 10 then further listens 309 on the positioning channel as required to perform positioning. After sending 312 the request 306 for positioning services, the mobile device 10 does not transmit any further requests for positioning services unless it requires to receive positioning packets and is unable to receive a positioning packet on the positioning channel within a predetermined time period or within a predetermined number of periods of listening for positioning packets.

The request 306 for positioning packets is received by the DT 30 during the scanning interval, in which the DT 30 is listening 302 on the advertising channel. In response, the DT 30 sends 310 an acknowledgement 313 on the advertising channel and also enters the positioning activation mode 170. In this mode 170, the DT 30 sends 314 multiple positioning packets 311 in relatively quick succession on the positioning channel.

The DT 30 transmits 300 another advertisement 301 after the interval between successive advertisements. The DT 30 does not perform any listening other than the listening 302 on the advertising channel immediately after the transmission 300 of the advertisement 301.

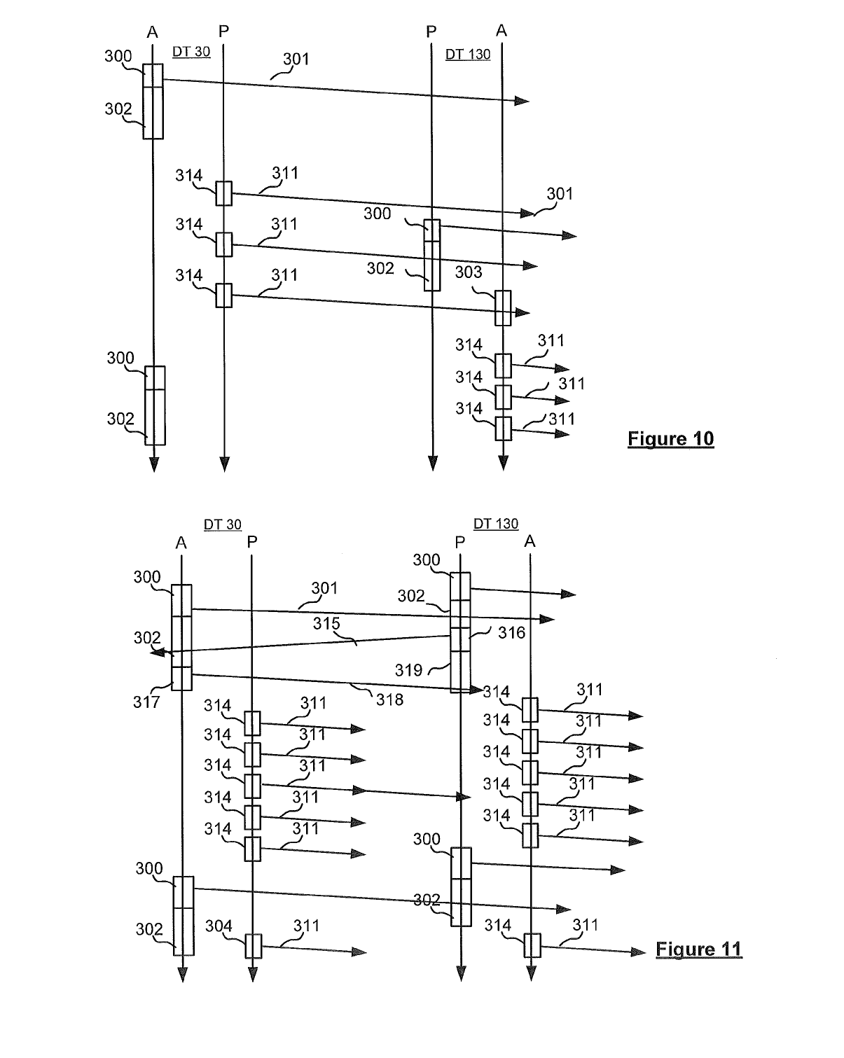

Operation of the DTs 30, 130 in being caused to transition from the idle mode 160 to the positioning activation mode, and also operation of the DTs in causing other DTs to so transition, will now be described with reference to FIGS. 10 and 11.

In FIG. 11, the first DT 30 is in positioning activation mode 170 or normal positioning mode 180. The differences in transmissions and listening operation in the absence of received signals is the same except that the frequency of transmissions of positioning packets is greater in the positioning activation mode 170.

The second DT 130 is in idle mode, and thus operates as shown in FIG. 8. In a period of listening 303 on the positioning channel, the second DT 130 receives a positioning packet 311 transmitted by the first DT 30 on the positioning channel. If system ID is supported, the second DT 130 checks that the system ID included in the positioning packet 314 is the same as a system ID stored in its memory 42. If it is or if system ID is not supported, the reception of the positioning packet causes the second DT 130 to transition from the idle mode 160 to the positioning activation mode 170. In this mode, the second DT 130 begins to transmit positioning packets on the positioning channel. The second DT 130 does not send any acknowledgement or other message to the first DT 30.

The commencement of the transmission of positioning packets by the second DT 130 has two main effects. The first is to provide positioning packets that may be received by the mobile device 10 that woke the first DT 30, thereby potentially giving the mobile device 10 another source of positioning packets from which to calculate its position. This occurs without the second DT 130 receiving any transmissions from the mobile device 10 nor the mobile device 10 receiving any transmissions from the second DT 130. The second is to provide another opportunity for other DTs 30, 130 that are in idle mode to transition to the positioning activation mode 170. Moreover, this can cascade such that the transitioning of one DT 30 from idle mode 160 to active positioning mode 170 in response to receiving a request for positioning services from a mobile device 10 can cause all other DTs 30, 130 (with the same system ID if system ID is supported) also to make the same transition.

FIG. 11 illustrates the second DT 130 intentionally waking the second DT 130. Here, the second DT 130 is in regular positioning mode 180 and the first DT 30 is in idle mode. The second DT 130 receives an advertisement 301 from the first DT 10 on the advertisement channel during a listening 302 period. In response, the second DT 130 transmits 316 a wake-up command 315 and then beings to listen 319 on the advertising channel. The wake-up command 315 is received by the first DT 30 during the listen period 302 immediately following the transmission 300 of the advertisement 301. In response to receiving the wake-up command 315, the first DT 30 sends 317 an acknowledgement 318 on the advertising channel, which is received by the second DT 130 during the listening 319 period. In response to receiving the wake-up command 315, the first DT 30 also transitions from the idle mode 160 to the positioning activation mode 170.

Effects of the features described above as being possessed by the DT 30 will now be described.

When a DT 30 powers up, it will enter idle mode. In this mode, no positioning packets are transmitted. However, advertisements are transmitted periodically. Since a receiver of the DT 30 is activated only for a short period of time, which is immediately following the transmission of an advertisement, the power consumption of the DT 30 is very low when the DT is in the idle mode.

In a system in which plural DTs are provided, the system will start with all of the DTs 30 being in idle mode. This is the case even if DTs are installed at different times, or are activated at different times. If a mobile device 10 requires positioning services, it responds to an advertisement from a DT by sending a request for positioning services. This is then received by the DT 30 that sent the advertisement to which the mobile device responded. In response, the DT 30 enters the positioning activation mode 170. In this mode, the DT 30 stops transmitting advertisements. In this mode, the DT 30 transmits positioning packets at a relatively high frequency or rate. These positioning packets can then be used by the mobile device 10 to calculate its position.

A neighbouring DT 130 will likely not receive the request for positioning services transmitted by the mobile device 10. However, if the transmission of advertisements by the neighbouring DT 130 happens to coincide with the transmission of advertisements by the first DT 30, then the neighbouring DT 130 may be listening/scanning for positioning service requests at the same time as the first DT.

Other than receiving a signal directly from the mobile device 10, there are two possibilities for the neighbouring DT 130 being activated to enter the positioning activation mode from the idle mode. One possibility is that the DT 30 receives an advertisement from the neighbouring DT 130 whilst the first DT is in the regular positioning mode. In this case, the first DT 30 transmits a wake-up command to the neighbouring DT 130, receipt of which causes the neighbouring DT 130 to enter the positioning activation mode 170. Alternatively, the neighbouring DT 130 may transition from the idle mode 160 to the positioning activation mode 170 in response to receiving a positioning packet from the first DT 30. If the neighbouring DT 130 is located such as to be able to receive signals from the first DT 30, it is very likely that the neighbouring DT 130 will enter the positioning activation mode 170 shortly after the first DT enters the positioning activation mode.

When the neighbouring DT 130 enters the positioning activation mode 170, it begins to transmit positioning packets at a high frequency or rate. If the mobile device 10 is within range of the neighbouring DT 130, these positioning packets can be used to allow the mobile device 10 to calculate its location with a greater accuracy or degree of confidence than is possible when receiving positioning packets from only one DT.

As well as the one neighbouring DT 130 entering the positioning activation mode 170 shortly after the first DT 30 enters the positioning activation mode, all other DTs that are located such as to be able to receive signals from the first DT 30 also will enter the positioning activation mode 170. This increases the possibility that the mobile device 10 will be able to receive positioning packets from multiple DTs 30, thereby providing greater possibilities for the mobile device 10 being able to calculate its location to a high degree of confidence and/or high accuracy. Moreover, this is achieved without any of the neighbouring DTs 130 having received a request for positioning services from the mobile device 10. In effect, the entering of one of the DTs 30 into the positioning activation mode 170 causes neighbouring DTs also to enter the positioning activation mode.

Each DT 30, 130 then transitions from the positioning activation mode 170 to the regular positioning mode 180 after a predetermined time, for instance two seconds. When in the regular positioning mode 180, the DT 30 is not responsive to signals from other DTs 130 to remain in the regular positioning mode or enter the positioning activation mode 170. Instead, the DTs 30 when in the regular positioning mode 180 are responsive only to requests for positioning services from mobile devices 10 to enter the positioning activation mode 170. This prevents the DTs 30 from keeping each other in the positioning activation mode 170 or the regular positioning mode 180 indefinitely. Instead, if no mobile device 10 transmits a request for positioning services, the DTs 30 will revert to the idle mode 160 after the time out 185 has expired from the regular positioning mode 180.

The configuration of the DTs to transition from the idle mode 160 to the positioning activation mode 170 in response to receiving a signal from another DT 130 has the effect of reducing power consumption at the mobile terminal 10. This occurs because the mobile terminal 10 can cause multiple DTs 30 to enter the positioning activation mode 170 by sending a positioning service request to one DT 30. Instead of reducing power consumption at the mobile device 10, the mobile device may instead use its transceiver resources for some other purpose.

Moreover, the above-described effects can be achieved relatively simply. In the case of a DT 30, 130 provided with receiver and transmitter capabilities, it may be provided with the above-described features by reprogramming it, for instance by way of a software update.

There are also some negative effects of the above-described features. The first negative effect is potentially an increased time between a mobile device 10 transmitting a request for positioning services and receiving positioning packets from multiple DTs 30. The increased time may be derived from the fact that it may take longer for a neighbouring DT 130 to detect that the first DT 30, being the one that the mobile device 10 contacted, has entered the positioning activation mode 170, compared to the situation where the mobile device 10 responds to advertisements from each of the DTs 30, 130 within which it is in range.

Compared to a system in which positioning packets are transmitted regularly on a continuous basis, a negative effect obtained by the above features is the requirement for a mobile device 10 to send a request for positioning services to a DT 30. The continuous transmission of positioning packets in a system in which DTs 30 are powered by a connection to a mains power supply can thus provide an improved service to mobile devices 10.

Another effect that can be considered to be negative is the transitioning of one DT from idle mode 160 to the positioning activation mode 170 can cause all of the DTs that are within a given area also to transition to the positioning activation mode 170. This is the case even if a mobile device 10 requiring positioning services is unable to detect signals transmitted by the other DTs 130. This is ameliorated to some extent by configuring the DTs 30 to include a system identifier in transmitted packets, whether positioning packets, advertisements, positioning wake-up commands or some combination of these, and by configuring the DTs 30 to transition from the idle mode 160 to the positioning activation mode 170 only on detection of the system identifier in a received packet being the same as a system identifier stored within the memory 42. Through this feature, DTs that share a common system identifier can be woken whilst DTs having another system identifier will not be woken by the DTs with the first system identifier even if they are within range of one another. Of course, in this situation DTs having the other system identifier could be woken by the mobile device 10.

Although the embodiments have been described with reference to Bluetooth low energy (BLE) communications, it will be appreciated that the invention is not limited to this. Any other communication protocol, whether standard or proprietary, may be used in place of BLE. However, BLE has advantages, especially as regarding the power consumption of transceivers, which is particularly important in the case of battery-powered DTs, and also in terms of the anticipated ubiquity of BLE transceivers in mobile devices such as mobile phones, smartphones, laptop computers, digital cameras, personal music players, etc.

In prior art Bluetooth Low Energy (BLE) systems, one channel is used for all communications.

In the BLE embodiment described above in relation to FIGS. 8-11, two BLE channels are used: an advertising channel and a positioning channel. This is advantageous for a number of reasons. Firstly, it provides a better service for mobile devices 10 because the risk of a positioning packet transmitted by a DT colliding with an advertisement or wake-up message transmitted by another DT or with a request for positioning services transmitted by another mobile device 10 is reduced. It also allows positioning packets to be transmitted at a high rate, improving positioning service for mobile devices 10, without interfering with advertisements, requests for services, wake-up requests etc. that are transmitted on the advertising channel. It further allows other services to use the advertising channel. Moreover, this allows DTs greater opportunity to receive a relevant signal that would cause the DT to transition from idle mode 160 to active positioning mode 170. This can be said to provide an improved service for mobile devices 10 because it increases the possibility for a mobile device 10 to receive useful positioning signals from DTs other than the DT with which it requested a positioning service.

The positioning channel may be selected dynamically, for instance to be the channel with the lowest traffic. In this case, DTs 30, 130 indicate in advertisements which channel is the positioning channel.

In this specification, BLE means the version of the Bluetooth Low Energy protocol that is current at the priority date, namely the Low Energy section of Bluetooth version 4.0, and all future versions. Where a future version of the BLE standard is such that it is inconsistent with the above-described operation, BLE means the last version of the specification that is consistent with the above.

Although embodiments of the present invention have been described in the preceding paragraphs with reference to various examples, it should be appreciated that modifications to the examples given can be made without departing from the scope of the invention as claimed.

For instance, although two positioning modes are described in relation to the DTs 30, 130, in some embodiments only one positioning mode is provided. Advantageously if there is only one positioning mode, operation in the positioning mode is as described above in relation to the normal positioning mode 180.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-30. (canceled)

31. Apparatus comprising:
a battery power supply,
a radio-frequency transceiver,
a multi-element antenna, and
processor and memory including software that when executed by the processor controls it to cause the apparatus:
when in an idle mode, to broadcast positioning service advertisements and to refrain from broadcasting positioning packets,
when in a positioning mode to broadcast positioning packets from each of the elements of the antenna such as to allow a mobile device to determine a bearing to the mobile device from the apparatus, and
to transition from the idle mode to the positioning mode in response to receiving either a) a wake-up command or b) a positioning packet, from another apparatus including a multi-element antenna.

32. An apparatus as claimed in claim 31, wherein the apparatus is configured when in the positioning mode to respond to receiving an advertisement by transmitting a wake-up command.

33. Apparatus as claimed in claim 31, wherein the wake-up command includes a system identifier and wherein the apparatus is configured when in the idle mode to be responsive to receiving a wake-up command including a system identifier to compare the system identifier to a system identifier stored in the apparatus and to transition from the idle mode to the positioning mode only if there is a match between the two system identifiers.

34. Apparatus as claimed in claim 31, wherein the apparatus is configured when in the idle mode to activate a receiver of the transceiver for a relatively short proportion of the time between successive advertisement broadcasts and to deactivate the receiver for the remaining proportion of the time between the successive advertisement broadcasts.

35. Apparatus as claimed in claim 31, wherein the apparatus is configured when in the positioning mode to broadcast advertisements.

36. Apparatus as claimed in claim 35, wherein the apparatus is configured when in the positioning mode to broadcast advertisements periodically.

37. Apparatus as claimed in claim 31, wherein the positioning mode comprises a positioning activation mode and a regular positioning mode, the apparatus being configured to transition to the positioning activation mode from the idle mode and to transition to the regular positioning mode from the positioning activation mode.

38. Apparatus as claimed in claim 31, configured to transmit the advertisements on an advertising channel and to transmit the positioning packets on a different channel.

39. A method of operating apparatus comprising:
a battery power supply,
a radio-frequency transceiver,
a multi-element antenna, and
processor and memory including software,
the method comprising:
when in an idle mode, broadcasting positioning service advertisements and refraining from broadcasting positioning packets,
when in a positioning mode, broadcasting positioning packets from each of the elements of the antenna such as to allow a mobile device to determine a bearing to the mobile device from the apparatus, and
transitioning from the idle mode to the positioning mode in response to receiving either a) a wake-up command or b) a positioning packet, from another apparatus including a multi-element antenna.

40. A method as claimed in claim 39, comprising, when the apparatus is in the positioning mode, responding to receiving an advertisement by transmitting a wake-up command.

41. A method as claimed in claim 39, wherein the wake-up command includes a system identifier and wherein the method comprises when the apparatus is in the idle mode responding to receiving a wake-up command including a system identifier by comparing the system identifier to a system identifier stored in the apparatus and transitioning from the idle mode to the positioning mode only if there is a match between the two system identifiers.

42. A method as claimed in claim 39, comprising when the apparatus in the idle mode activating a receiver of the transceiver for a relatively short proportion of the time between successive advertisement broadcasts and deactivating the receiver for the remaining proportion of the time between the successive advertisement broadcasts.

43. A method as claimed in claim 39, comprising broadcasting advertisements when the apparatus is in the positioning mode.

44. A method as claimed in claim 43, comprising broadcasting advertisements periodically when the apparatus is in the positioning mode.

45. A method as claimed in claim 39, wherein the positioning mode comprises a positioning activation mode and a regular positioning mode, the method comprising the apparatus transitioning to the positioning activation mode from the idle mode and transitioning to the regular positioning mode from the positioning activation mode.

46. A method as claimed in claim 39, comprising transmitting the advertisements on an advertising channel and transmitting the positioning packets on a different channel.

47. A computer program comprising instructions that when executed by computer apparatus comprising a battery power supply, a radio-frequency transceiver, and a multi-element antenna control it to perform the method comprising:
when in an idle mode, broadcasting positioning service advertisements and refraining from broadcasting positioning packets,
when in a positioning mode, broadcasting positioning packets from each of the elements of the antenna such as to allow a mobile device to determine a bearing to the mobile device from the apparatus, and
transitioning from the idle mode to the positioning mode in response to receiving either a) a wake-up command or b) a positioning packet, from another apparatus including a multi-element antenna.

48. A non-transitory computer-readable storage medium having stored thereon computer-readable code, which, when executed by computing apparatus comprising a battery power supply, a radio-frequency transceiver, and a multi-element antenna, causes it to perform a method comprising:
when in an idle mode, broadcasting positioning service advertisements and refraining from broadcasting positioning packets,
when in a positioning mode, broadcasting positioning packets from each of the elements of the antenna such as to allow a mobile device to determine a bearing to the mobile device from the apparatus, and
transitioning from the idle mode to the positioning mode in response to receiving either a) a wake-up command or b) a positioning packet, from another apparatus including a multi-element antenna.

49. Apparatus comprising:
a Bluetooth Low Energy transceiver; and
processor and memory including software that when executed by the processor controls it to cause the apparatus:
to transmit advertisements for positioning services on a first channel; and
to broadcast positioning packets on a second channel such as to allow a mobile device to determine a bearing to the mobile device from the apparatus,
wherein the first and second channel are on different frequencies.

50. Apparatus as claimed in claim 49, configured to operate the receiver to listen for transmissions on the first channel for a period of time after the transmission of an advertisement on the first channel.

51. Apparatus as claimed in claim 49, configured to operate the receiver to listen for transmissions on the second channel for a period of time after the transmission of an advertisement on the first channel.

52. Apparatus as claimed in claim 49, configured to respond to receiving a transmission comprising a) a request for positioning services, b) an advertisement for positioning services or c) a wake-up request on the first channel to transition from an idle mode in which positioning packets are not broadcast to a positioning mode in which positioning packets are broadcast.

53. Apparatus as claimed in claim 49, configured to respond to receiving a positioning packet on the second channel to transition from an idle mode in which positioning packets are not broadcast to a positioning mode in which positioning packets are broadcast.

54. A method of operating apparatus comprising:
a Bluetooth Low Energy transceiver; and
processor and memory including software,
the method comprising:
transmitting advertisements for positioning services on a first channel; and
broadcasting positioning packets on a second channel such as to allow a mobile device to determine a bearing to the mobile device from the apparatus,
wherein the first and second channel are on different frequencies.

55. A method as claimed in claim 54, comprising operating the receiver to listen for transmissions on the first channel for a period of time after the transmission of an advertisement on the first channel.

56. A method as claimed in claim 54, comprising operating the receiver to listen for transmissions on the second channel for a period of time after the transmission of an advertisement on the first channel.

57. A method as claimed in claim 54, comprising responding to receiving a transmission comprising a) a request for positioning services, b) an advertisement for positioning services or c) a wake-up request on the first channel by transitioning from an idle mode in which positioning packets are not broadcast to a positioning mode in which positioning packets are broadcast.

58. A method as claimed in claim 54, comprising responding to receiving a positioning packet on the second channel by transitioning from an idle mode in which positioning packets are not broadcast to a positioning mode in which positioning packets are broadcast.

59. A computer program comprising instructions that when executed by computer apparatus comprising a Bluetooth Low Energy transceiver control it to perform the method of claim 54.

60. A non-transitory computer-readable storage medium having stored thereon computer-readable code, which, when executed by computing apparatus comprising a Bluetooth Low Energy transceiver causes it to perform a method comprising:
transmitting advertisements for positioning services on a first channel; and
broadcasting positioning packets on a second channel such as to allow a mobile device to determine a bearing to the mobile device from the apparatus,
wherein the first and second channel are on different frequencies.
